(19) United States
(12) Patent Application Publication
(10) Pub. No.: US 2026/0366898 A1
(43) Pub. Date: Nov. 19, 2026

(54) MODULAR CORIOLIS FLOWMETER AND METHOD FOR PRODUCING A COIL DEVICE

(71) Applicant: Endress+Hauser Flowtec AG, Reinach (CH)

(72) Inventors: Marc Werner, Grenzach-Wyhlen (DE); Benjamin Schwenter, Ettingen (CH); Peppino Breda, Liestal (CH); Markus Schütz, Lampenberg (CH)

(21) Appl. No.: 19/135,294

(22) PCT Filed: Dec. 11, 2023
(86) PCT No.: PCT/EP2023/085188

§ 371 Date: Jun. 3, 2025

(30) Foreign Application Priority Data
Dec. 16, 2022 (DE) 10 2022 133 717.0

(51) Int. Cl. G01F 1/84

(52) U.S. Cl. CPC G01F 1/8422; G01F 1/8404

(57) ABSTRACT

A modular Coriolis flowmeter for determining a process variable of a flowable medium, includes: a measuring tube module including at least one measuring tube for guiding the medium; a carrier module including a receptacle for receiving the measuring tube module in a carrier module body, which includes a coil opening, wherein a coil device is arranged in the coil opening and includes a winding body and a coil wire, wherein the winding body includes a protrusion for securing the coil wire that is wound at least partially around the protrusion to form a coil; a measuring and/or operating circuit configured to apply an excitation signal to the coil device and/or to detect a sensor signal at the coil device.

The invention relates to a modular Coriolis flowmeter for determining a process variable of a flowable medium and to a method for producing a coil device of a modular Coriolis flowmeter.

Process measurement technology field devices with a vibration-type sensor and especially Coriolis flowmeters have been known for many years. The basic structure of such a measuring device is described in, for example, EP 1 807 681A1, wherein reference is made in full to this publication with respect to the structure of a generic field device in the context of the present invention.

Typically, Coriolis flowmeters have at least one or more vibratable measuring tubes which can be set to vibration by means of a vibration exciter. These vibrations are transmitted along the tube length and are varied by the type of flowable medium located in the measuring tube and by its flow rate. At another point in the measuring tube, a vibration sensor or, in particular, two vibration sensors spaced apart from one another can record the varied vibrations in the form of a measurement signal or a plurality of measurement signals. An evaluation unit can then determine the mass throughflow, the viscosity, and/or the density of the medium from the measurement signal(s).

Modular Coriolis flowmeters with interchangeable disposable measuring tube modules are known. For example, in WO 2011/099989 A1, a method is thus taught for producing a monolithically formed measuring tube arrangement of a Coriolis flowmeter with bent measuring tubes, wherein the measuring tube body for the respective measuring tubes is first formed as a solid made of a polymer, and the channel for conducting the flowable medium is subsequently machined into said solid. WO 2011/099989 A1, like U.S. Pat. No. 10,209,113 B2, teaches a connecting body that is configured to receive and support a replaceable measuring tube module with thin-walled plastic tubes. The measuring tube module is fastened, via the connecting body, in a receiving module equipped with the necessary exciters and sensors. Modular Coriolis flowmeters, in which the excitation coil and the sensor coils are arranged on a metallic housing, and excitation and sensor magnets are used on the measuring tube module, are susceptible to parasitic influences when measuring the process variable in the event of magnetic field changes. These cannot be fully compensated for by a factory adjustment. WO 2022/122420 A1 provides a remedy for this problem by teaching the provision of an electrically insulating coil holder in the metallic wall of the carrier module.

The object of the invention is to further develop the cited prior art.

The object is achieved by the modular Coriolis flowmeter according to claim 1 and by the method for producing a coil device according to claim 15.

The modular Coriolis flowmeter according to the invention for determining a process variable of a flowable medium comprises:
a measuring tube module,
wherein the measuring tube module has at least one measuring tube for guiding the medium;
a carrier module with a receptacle for receiving the measuring tube module in a carrier module body,
wherein the carrier module body has at least one housing body opening,
wherein a coil device is arranged in the at least one housing body opening,
wherein the coil device has a winding body and a coil wire,
wherein the winding body has at least one protrusion, in particular having at least portions with a hollow-cylindrical shape, for securing the coil wire,
wherein the coil wire is wound at least partially around the at least one protrusion in order to form a coil;
a measuring and/or operating circuit,
wherein the measuring and/or operating circuit is designed to apply an excitation signal to the at least one coil device and/or to detect a sensor signal at the at least one coil device.

The advantage of the solution according to the invention is not only the simplification of the assembly of the coil device on the carrier module, but also the simplification, resulting from the structural design of the winding body, of the winding of the coil wire to form the coil.

Advantageous embodiments of the invention are the subject matter of the dependent claims.

One embodiment provides that the coil device comprise a contacting device,
wherein the contacting device has at least one coil opening through which the at least one protrusion extends,
wherein the contacting device has at least one contacting surface for the coil wire, in particular on a front side,
wherein the coil wire is electrically connected to the contacting device, in particular to the contacting surface.

The contacting device, preferably in the form of a printed circuit board or a circuit board, simplifies the electrical connection of the coil device to the measuring and/or operating circuit. The contacting device has its own mechanical stability, so that the connection of the ends of the coil wire to the contact surfaces is simplified in terms of assembly.

One embodiment provides that the winding body have two protrusions,
wherein the contacting device has two coil openings,
wherein a protrusion extends through each of the two coil openings,
wherein the coil wire is wound around the two protrusions.

One embodiment provides that the two protrusions be oriented such that the coil wire is wound in an oval shape.

The advantage of the oval shape of the wound coil wire is a reduction in sensitivity or loss due to manufacturing tolerances when, for example, arranging the magnets on the measuring tube or positioning the opening for the coil device.

One embodiment provides that, in a region around the at least one protrusion, in particular around the two protrusions, there be a depression in the winding body.

One embodiment provides that the contacting device be planar at least on its rear side and rest with the rear side on a front surface of the winding body.

One embodiment provides that the contacting device on a rear side have at least one contacting surface for a connecting wire.

Alternatively, the contacting device on the front side can also have at least one contacting surface for a connecting wire. Alternatively, the connecting wire can be electrically connected to the contacting surfaces of the coil wire.

One embodiment provides that the connecting wire comprise a coaxial cable with which the coil device is in communication with the measuring and/or operating circuit.

One embodiment provides that the winding body have a projection which is designed such that it acts as a strain relief upon the connecting wire.

One embodiment provides that the coil device comprise a coil carrier,
wherein the coil is arranged in a coil carrier receptacle such that the contacting device rests on a receiving surface of the coil carrier.

The coil device protects the coil device from environmental influences such as liquids or mechanical vibrations. In addition, the coil device simplifies the centering of the coil device in the provided opening.

One embodiment provides for a hardened casting compound to be present in the coil carrier receptacle.

The casting compound is preferably used to create a material-to-material connection between the coil carrier and the coil device.

One embodiment provides that the coil carrier have a separating membrane which separates the coil wire from the receptacle of the carrier module body,
wherein the separating membrane has a material thickness of 0.05<d≤2 millimeters, in particular 0.1≤d≤1.5 millimeters and preferably 0.2≤d≤1 millimeters.

The selected material thickness ensures the necessary mechanical stability, while simultaneously achieving a minimal reduction in the generated magnetic field or the magnetic field to be measured.

One embodiment provides that the measuring tube module be or be able to be connected in a mechanically detachable manner to the carrier module, in particular to the carrier module body.

One embodiment provides that the carrier module have a coil device fastener which is designed to fasten the coil device in the at least one housing body opening at a variable distance from the measuring tube module arranged in the receptacle.

The coil device fastening device allows the optimal position of the coil device to be manually adjusted when adjusting the carrier module.

The method according to the invention for producing a coil device for an, in particular modular, Coriolis flowmeter, comprising the method steps of:
arranging a contacting device on a winding body for fastening and/or electrically contacting a coil wire,
wherein the winding body has at least one protrusion,
wherein the contacting device has at least one coil opening,
wherein the at least one protrusion is passed through the at least one coil opening;
winding the coil wire around the at least one protrusion in order to form a coil,
wherein the winding body assumes the role of a winding mandrel; and
connecting the coil wire to at least one contacting surface of the contacting device.

One embodiment provides that, through the at least one protrusion, in particular in each case, a hole extend for receiving a counter disc,
wherein the counter disc is arranged on the winding body when the coil wire is wound.

One embodiment provides for further method steps, namely:
arranging the coil in a coil carrier receptacle of a coil carrier; and/or
heating the coil wire during winding, either thermally or inductively, or subsequently in a furnace; and
allowing the wound coil wire to harden; and/or
casting the coil carrier receptacle with a casting compound.

The invention is explained in greater detail with reference to the following figures, in which:

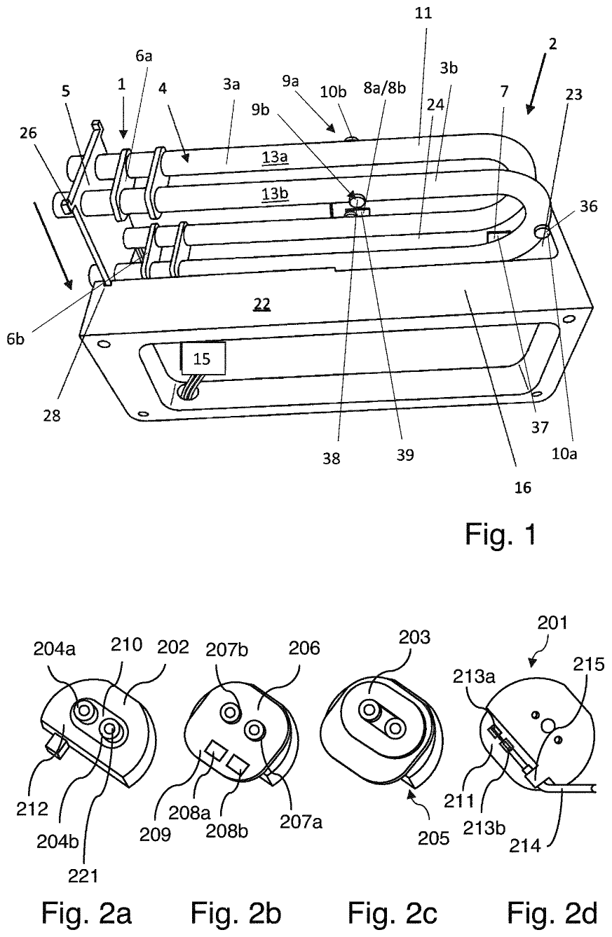

FIG. 1 shows an embodiment of the modular Coriolis flowmeter;

FIG. 2a-d are four perspective views of individual production steps of the coil device;

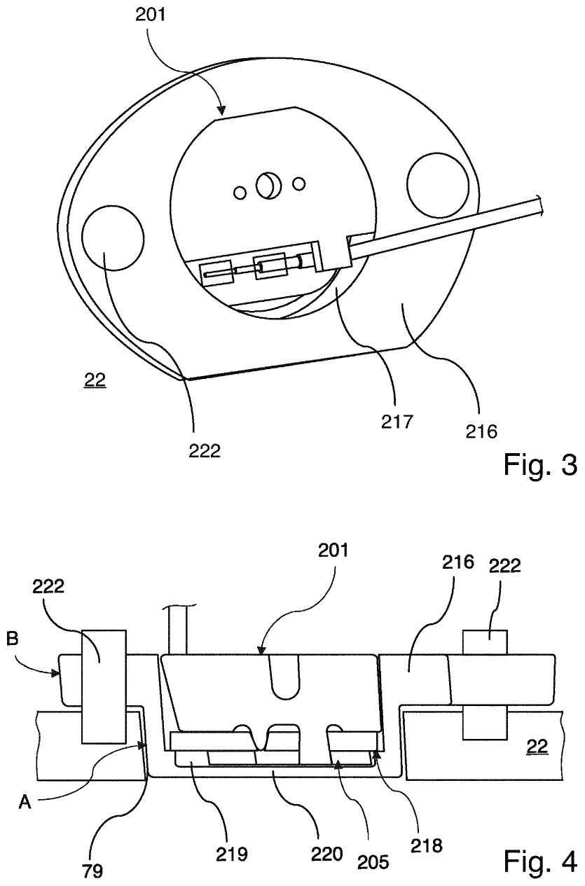

FIG. 3 is a perspective view of the embodiment of the coil device from FIG. 2 in a coil carrier;

FIG. 4 is a cross-sectional view of an obliquely sectioned representation of an embodiment of FIG. 3; and

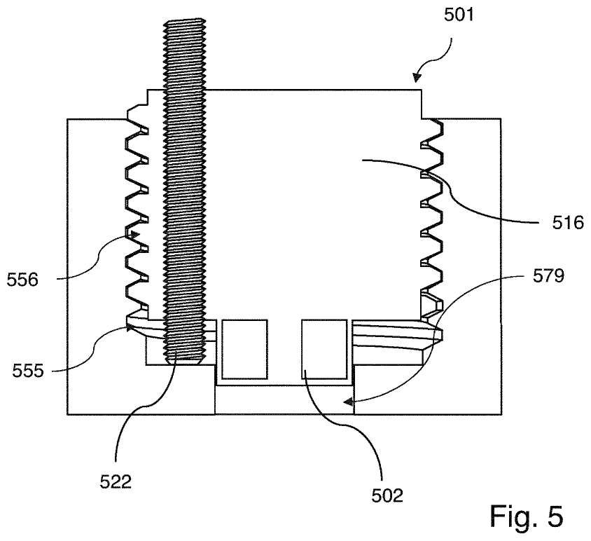

FIG. 5 is a longitudinal sectional view through a housing body opening with the coil device and coil device fastener arranged.

FIG. 1 is a perspective view of a modular Coriolis flowmeter 2, which is particularly suitable for pharmaceutical bioprocess applications. A Coriolis flowmeter 2 is a measuring device for measuring a mass flow, a viscosity, a density, and/or a variable derived therefrom, of a flowable medium. The measuring tube module 4 is suitable for being inserted into a receptacle 23 of a receiving module 16 in a replaceable, i.e., mechanically detachable, manner. For this purpose, only individual components of the vibration exciter and the vibration sensors, in this case the respective magnet arrangements 9a, 9b, are attached to the measuring tube module 4, in particular to the measuring tubes 3a, 3b of the measuring tube module 4. The magnet arrangement 9a, 9b has at least one excitation magnet and at least one sensor magnet. According to the illustrated embodiment, the two magnet arrangements 9a, 9b each have exactly one excitation magnet 36 and exactly two sensor magnets 38. The further components of the vibration exciter and the vibration sensors are arranged in the receiving module 16, in particular in the receptacle 23—in particular in a coil receptacle of the carrier module body 22—which is suitable and designed for receiving the measuring tube module 4. The measuring tube module 4 has two bent measuring tubes 3a, 3b that run in parallel to one another and are connected to one another via a coupler arrangement 1, consisting of four coupler elements 6, and via a fixing body arrangement 5. Two coupler elements 6a are connected in an integrally bonded manner in an inlet and two further coupler elements 6b are connected in an integrally bonded manner in the outlet of the respective measuring tubes 3a, 3b. The measuring tubes 3a, 3b are shaped such that the flow direction, indicated by two arrows, in the inlet is oriented opposite to the flow direction in an outlet. A flow divider (not shown) which has a process connection for connecting to a hose system and/or plastic tube system can be respectively arranged in the inlet and in the outlet. According to one embodiment, exactly one flow divider body can be provided instead of two separate flow dividers, the flow divider body of which is slid onto the inlet and outlet and also contributes to decoupling the measuring tube module 4 from the environment after installation in the receiving module 16. The individual coupler elements 6i are plate-shaped and designed in one or two parts. The coupler elements 6i may respectively completely or only partially encompass the measuring tubes. The measuring tubes 3a, 3b are U-shaped, i.e., they each have two legs 11 running substantially in parallel to one another, which are connected via a bent partial segment. The magnet arrangement 9a, 9b is arranged on each measuring tube 3a, 3b. In the bent partial segment, a magnet 10a—in particular, an excitation magnet 36—of the magnet arrangement 9a, 9b is arranged and forms a component of the vibration exciter. In each of the two legs 11, a magnet 10ba—in particular, a sensor magnet 38—is attached, which forms part of the vibration exciter. The magnets 10i are attached to attachment surfaces. In the embodiment, the attachment surfaces are located on the respective measuring tubes 3a, 3b.

The measuring tube module 4 is partially inserted into a receptacle 23 on a receiving module 16. An arrow indicates the insertion direction. In the embodiment, this direction runs perpendicular to a longitudinal direction of the receptacle 23. The receptacle can also be designed such that the measuring tube module 4 is inserted in the longitudinal direction of the receptacle. The receiving module 16 has a measuring and/or operating circuit 15 that is connected to the vibration exciters and vibration sensors, in particular to the respective coil systems, and is designed to generate and/or detect a magnetic field that changes over time. The measuring and/or operating circuit 15 has integrated circuits in the form of a microcontroller or an ASIC. Furthermore, the measuring and/or operating circuit 15 optionally has electronic components such as electrical resistors, transistors, diodes, amplifiers, filters, and/or capacitors. The measuring and/or operating circuit 15 may also have a permanent memory (ROM, PROM, RAM, EPROM, etc.). The receiving module 16 has a carrier module body 22 in which the receptacle 23 is located. The carrier module body 22 has, at least in portions, an electrically conductive and in particular ferromagnetic material. Furthermore, the carrier module body 22 can be formed from a metallic material. The connecting body 5 for the measuring tube module 4 has mounting surfaces 26 that serve to arrange the measuring tube module 4 in a predetermined position in the receiving module 16. According to the illustrated embodiment, the perpendicular of the mounting surface 26 points perpendicularly to the longitudinal direction of the measuring tube module 4. According to a further advantageous embodiment, the perpendicular of the mounting surface 26 points in the direction of the longitudinal axis of the measuring tube module 4. The surface of the carrier module body 22 in contact with the mounting surface 26 of the connecting body 5 is the bearing surface 27.

The receiving module 16 has two side surfaces that are oriented in parallel to one another and delimit the receptacle 23 transversely to the longitudinal direction of the receptacle 23. The sensor coils 39 of the vibration sensors 8a, 8b and the excitation coils 37 of the vibration exciter 7 are arranged in the side surfaces or in openings inserted in the side surfaces. The sensor coils 39 are arranged offset from the excitation coils 37 in the longitudinal direction of the receptacle 23. The excitation coil 37 and the two sensor coils 39, which are arranged on a side surface of the receiving module 16, are located in a common coil plane. Furthermore, the excitation coils 37 and sensor coils 39 in the illustrated embodiment are each designed as plate coils and are recessed in the corresponding side surface. On one side surface, the excitation coil 37 and the sensor coils 39 are arranged essentially such that, when the measuring tube module 3 is installed, they are located opposite the corresponding magnet arrangements 9a, 9b. A respective guide that extends perpendicularly to the longitudinal direction of the receptacle 23 and in parallel to the coil plane is incorporated into the two side surfaces. The connecting body 5 can be inserted into this guide. According to the illustrated embodiment, the guide extends over two end faces of the receptacle 23. This allows the measuring tube module 4 to be inserted perpendicularly to the longitudinal direction of the measuring tube module 4. According to a further embodiment, the guide extends exclusively over one end face. In this case, the measuring tube module 4 is to be inserted into the receiving module 16 in the longitudinal direction of the measuring tube module 4 or the receiving module 16.

FIG. 2 a to d show four production steps of an embodiment according to the invention of the excitation coil or the sensor coil, hereafter referred to as the coil device 201. The coil device 201 is not—as shown in FIG. 1—designed as a plate coil. Instead, the coil device 201 has a winding body 202 (see FIG. 2a). The winding body 202 is formed from an electrically insulating material (e.g., plastic) and can be produced by means of an injection-molding process. The winding body 202 forms a base body of the coil 205, to which the coil wire 203 is fastened. The winding body 202 has two protrusions 204a, 204b around which the coil wire 203 is wound in a later production step. The illustrated protrusions 204a, 204 have, at least in portions, a cylindrical shape. However, they can also take any other shape that is suitable for holding the wound coil wire 203 in position. Alternatively, the winding body 202 can also have exactly one protrusion 204 around which the coil wire 203 is wound. A through-hole 221 extends through each of the two protrusions 204a, 204b and the winding body 202. The two holes each serve as a receptacle for a cylindrical pin of a counter disc, which is attached to the winding body 202 when the coil wire 203 is wound onto the winding body and serves to hold the winding body 202 and to limit the winding surface of the coil wire 203. The winding body 202 has a depression 210 on its front surface 212. The depression 210 is shaped such that it surrounds the two protrusions 204a, 204b. The depression 210 ensures that the front surface 212 of the winding body 202 is planar and that a contacting device 206, which is also planar at least on the rear side 211, rests on the front surface 212. The depression 210 prevents a rounded transition from forming between the protrusions 204a, 204b and the front surface 212, which would result in the contacting device 206 not resting so as to be planar on the front surface 212.

In a second production step (FIG. 2b), the contacting device 206 is attached to the winding body 202. The contacting device 206 has two coil openings 207a, 207b through which the protrusions 204a, 204b of the winding body 202 are guided. In the illustrated case, the contacting device 206 is a printed circuit board or circuit board with two contact surfaces 208 on the front side 209. The contacting device 206 serves, on the one hand, to contact the coil wire 203 and, on the other, to contact a connecting wire 214 with which the coil 205 is connected to the measuring and/or operating circuit 15.

In a third production step (FIG. 2c), the coil wire 203 is wound around the winding body 202, in particular around the two protrusions 204a, 204b. This results in an oval coil shape. For winding the coil wire 203, the winding body 202 is connected to a counter disc. The winding body 202 acts as a winding mandrel during winding. First, one end of the coil wire 203 is connected to a contact surface 208. The coil wire 203 is then wound around the second end of the coil wire 203, and connected to the second, still free, contact surface 208. Alternatively, the coil wire 203 can also be connected to the measuring and/or operating circuit via a connection print. Alternatively, screws or pins can be provided to connect the coil wire 203 and ensure an electrical connection between the coil wire 203 and the measuring and/or operating circuit.

Alternatively, the winding body 202 may have only one protrusion 204, around which the coil wire 203 is wound. In this case, the protrusion 204 may have an oval cross-section. Thus, an oval-shaped coil 205 can also be formed. The coil wire 203 can be integrally connected to the contacting device 206 or can be held in place in a self-supporting manner by its own mechanical tension. The coil wire 203 is preferably a self-bonding wire (copper enamel wire) or a two-layer wire.

Once the coil wire 203 is wound and connected to the contacting surfaces 208a, 208b, a coil 205 is formed, which still needs to be contacted with a connecting wire 214 (see FIG. 2d). For this purpose, the contacting device 206 on a rear side 211 has two contacting surfaces 213a, 213b, which are arranged offset from one another and which are in electrical contact with the contacting surfaces 208a, 208b. The contacting surfaces 213a, 213b can be formed as separate coatings made of conductive material. The connecting wire 214 is designed as a coaxial cable, wherein the inner conductor is contacted with the contacting surface 213a, and the outer conductor is contacted with the contacting surface 213b. The winding body 202 also has a projection 215, which has a substantially rectangular basic shape. The projection 215 serves to relieve the strain on the connecting wire 214. This runs between the contacting device 206, in particular between the rear side 211 of the contacting device 206 and the projection 215. The projection 215 is designed such that a force acting upon the bent connecting wire 214 is absorbed in the longitudinal direction, and a tearing of the connection to the contacting surfaces 213a, 213b is prevented. In the embodiment of FIG. 2d, the coil device 201 can be arranged in an opening in the carrier module body 22 or behind a separation of the carrier module body 22. Alternatively, the coil device 201 can also be arranged in a coil carrier (see FIG. 3), which is designed to protect the coil device 201 from environmental influences such as leakage medium, cleaning medium, or a collision with the measuring tube.

FIG. 3 is a perspective view of the rear side of the coil device embodiment from FIG. 2d in a coil carrier 216. The coil carrier 216 has a coil carrier receptacle 217 into which the coil device 201 from FIG. 2d is inserted. The coil carrier receptacle 217 is designed as a blind-hole and takes the shape of the coil device 201 at least in portions. The coil carrier 216 is arranged on the carrier module body 22 and, at a variable distance from the measuring tube module arranged in the receptacle, is or can be fastened via at least one, in particular, as shown, via two coil device fasteners 222. The coil device fastener 222 may be a screw, an adhesive, or a wedge body. Alternatively, a positive-locking connection between the coil carrier 216 and the receiving module body 22 can be formed by a forming process or clamping connection (e.g., by caulking or bending of bending tabs).

FIG. 4 is a cross-sectional view of an obliquely sectioned representation of an embodiment of FIG. 3. The carrier module body 22 has a continuous housing body opening 79 in which the coil carrier 216 is arranged. The coil carrier 216 is connected to the carrier module body 22 via at least one coil device fastener 222 or, in the case shown, via two coil device fasteners 222. The distance of the coil 205 and the coil support 216 from the measuring tube and/or the inclination of the coil 205 and the coil support 216 relative to the measuring tube can be adjusted via the coil device fastener 222. The coil carrier 216 has a receiving surface 218 in the coil carrier receptacle, on which the coil device 201, in particular the coil 205, in particular the contacting device of the coil, rests. The coil carrier 216 has a separating membrane 220 which separates the coil device 201, in particular the coil 205, from the measuring tube and the interior of the receptacle of the carrier module. The separation membrane 220 thus protects the coil device 201 from liquids that escape in the event of a leak in the measuring tube or that are used to clean the carrier module. The separation membrane 220 has a material thickness of 0.05≤d≤2 millimeters, in particular 0.1≤d≤1.5 millimeters and preferably 0.2≤d≤1 millimeters. The coil carrier 216 is shaped such that a first portion A can be arranged in a fitting manner in the housing body opening 79, and a second portion B-whose cross-sectional area is larger than the cross-sectional area of the coil carrier 216 in the first portion A-rests on the receiving module body 22 and thus limits the coil carrier 216 in its mounting direction. The second portion B is designed as a stop. The coil carrier receptacle also contains a hardened casting compound 219. This is cast into the coil carrier receptacle 217 after the coil device 201 has been arranged in the coil carrier 216. There, it fills the free volume between the coil device 201 and the coil carrier 216.

FIG. 5 is a longitudinal sectional view through a housing body opening 579 with the coil device 501 and the coil device fastener 522 arranged. The coil carrier 516 has a coil 502 in a front portion, which can be an excitation coil or a sensor coil. The housing body opening 579 for the coil device 501 has a helical housing body opening internal thread 555. The coil carrier 516 has a matching external coil carrier thread 556. In the illustrated case, the coil carrier 516 is screwed into the housing body opening 579 so that it can be displaced in the longitudinal direction of the housing body opening 579.

The position of the coil device 501 relative to a magnet arrangement or a permanent magnet on the measuring tube of the replaceable measuring tube module can be adjusted via a coil device fastener 522. In the illustrated case, the coil device fastener 522 is a screw with which the position of the coil device 501 can be blocked and secured.

### LIST OF REFERENCE SIGNS

Coupler arrangement 1
Coriolis flowmeter 2
Measuring tube 3i
Measuring tube module 4
Fixing body arrangement 5
Coupler element 6
Vibration exciter 7
Vibration sensor 8
Magnet arrangement 9
Magnet 10
Leg 11
Measuring tube body 13
Measuring and/or operating circuit 15
Receiving module 16
Carrier module body 22
Receptacle 23
Mounting surface 26
Guide 28
Excitation magnet 36
Excitation coil 37
Sensor magnet 38
Sensor coil 39
Housing body opening 79
Coil device 201
Winding body 202
Coil wire 203
Protrusion 204i
Coil 205
Contacting device 206
Coil opening 207
Contacting surface 208
Front side 209
Depression 210
Rear side 211
Front surface 212
Contacting surface 213
Connecting wire 214
Projection 215
Coil carrier 216
Coil carrier receptacle 217
Receiving surface 218
Casting compound 219
Separating membrane 220
Hole 221
Coil device fastener 222
Coil device 501
Coil 502
Coil carrier 516
Coil device fastener 522
Housing body opening internal thread 555
Housing body opening 579

1-16. (canceled)

17. A modular Coriolis flowmeter for determining a process variable of a flowable medium, the flowmeter comprising:
a measuring tube module including at least one measuring tube for guiding the medium;
a carrier module including a receptacle in a carrier module body configured to receive the measuring tube module, wherein:
the carrier module body includes at least one coil opening;
a coil device is arranged in the at least one coil opening;
coil device includes a winding body and a coil wire;
the winding body includes at least one protrusion configured to secure the coil wire; and
the coil wire is wound at least partially around the at least one protrusion as to form a coil;
a measuring and/or operating circuit configured to supply an excitation signal to the at least one coil device and/or to detect a sensor signal at the at least one coil device.

18. The flowmeter according to claim 17, wherein:
the coil device includes a contacting device;
the contacting device includes at least one coil opening through which the at least one protrusion extends;
the contacting device includes at least one contacting surface for the coil wire; and
the coil wire is electrically connected to the contacting surface of the contacting device.

19. The flowmeter according to claim 17, wherein:
the winding body includes two protrusions;
the contacting device at least one protrusion two coil openings;
one of the two protrusions extends through each of the two coil openings; and
the coil wire is wound around the two protrusions.

20. The flowmeter according to claim 19, wherein the two protrusions are oriented such that the coil wire is wound in an oval shape.

21. The flowmeter according to claim 17, wherein, in a region around the at least one protrusion, the winding body includes a depression.

22. The flowmeter according to claim 18, wherein the contacting device is planar at least on a rear side, which rear side rests on a front surface of the winding body.

23. The flowmeter according to claim 18, wherein the contacting device on a rear side includes at least one contacting surface adapted for a connecting wire.

24. The flowmeter according to claim 23, wherein the connecting wire comprises a coaxial cable with which the coil device is in communication with the measuring and/or operating circuit.

25. The flowmeter according to claim 23, wherein the winding body includes a projection configured to act as a strain relief upon the connecting wire.

26. The flowmeter according to claim 18, wherein the coil device includes a coil carrier, wherein the coil is arranged in a coil carrier receptacle such that the contacting device rests on a receiving surface of the coil carrier.

27. The flowmeter according to claim 26, wherein a hardened casting compound is disposed in the coil carrier receptacle.

28. The flowmeter according to claim 26, wherein the coil carrier includes a separating membrane that separates the coil wire from the receptacle of the carrier module body, wherein the separating membrane has a material thickness greater than or equal 0.05 millimeters (mm) and less than or equal to 2 mm.

29. The flowmeter according to claim 26, wherein the material thickness is greater than or equal to 0.2 mm and less than or equal to 1 mm.

30. The flowmeter according to claim 17, wherein the measuring tube module is embodied to be connected in a mechanically detachable manner to the carrier module body.

31. The flowmeter according to claim 17, wherein the carrier module includes a coil device fastener adapted to secure the coil device in the at least one coil opening at an adjustable distance from the measuring tube module arranged in the receptacle.

32. A method for manufacturing a coil device for a modular Coriolis flowmeter, the method comprising:
arranging a contacting device on a winding body configured for fastening and/or electrically contacting a coil wire, wherein:
the winding body includes at least one protrusion;
the contacting device includes at least one coil opening; and
the at least one protrusion is passed through the at least one coil opening;
winding the coil wire around the at least one protrusion as to form a coil, wherein the winding body serves as a winding mandrel; and
connecting the coil wire to at least one contacting surface of the contacting device.

33. The method according to claim 32, wherein a hole extends through the at least one protrusion for receiving a counter disc, wherein the counter disc is arranged on the winding body when the coil wire is wound.
